(19) United States
(12) Patent Application Publication
(10) Pub. No.: US 2024/0097260 A1
(43) Pub. Date: Mar. 21, 2024

(54) STORAGE METHOD

(71) Applicant: ISUZU MOTORS LIMITED, Yokohama-shi (JP)

(72) Inventor: Shinsaku YAMAGUCHI, Fujisawa-shi (JP)

(21) Appl. No.: 18/468,777

(22) Filed: Sep. 18, 2023

(30) Foreign Application Priority Data
Sep. 20, 2022 (JP) 2022-149097

(51) Int. Cl. H01M 50/249; H01M 10/46; H01M 10/48; H01M 50/233

(52) U.S. Cl. CPC H01M 50/249; H01M 10/46; H01M 10/48; H01M 50/233

(57) ABSTRACT

A storage method of the present disclosure includes keeping an inside of a storage, configured to store a replaceable battery that is configured to be detachably attached to a vehicle, at a constant temperature; and storing a plurality of the batteries in the storage.

### TECHNICAL FIELD

The present disclosure relates to a storage method.

### BACKGROUND ART

Conventionally, in a vehicle such as an electric vehicle, a battery is fixed to a vehicle body, and the battery is charged via a charging device provided in the vehicle as disclosed in, for example, Patent Literature (hereinafter, referred to as PTL) 1.

### CITATION LIST

### Patent Literature

### PTL 1

Japanese Patent Application Laid-Open No. 2021-145447

### SUMMARY OF INVENTION

### Technical Problem

When a battery is fixed to a vehicle, due to safety restrictions on the battery, the nominal performance of the battery cannot be fully used and charging takes a long time. Therefore, it has been taken into consideration to employ a replaceable battery as a battery to be mounted on a vehicle. In this case, an object resides in the provision of a battery that is in an appropriate state in the vehicle at the time of the replacement.

An object of the present disclosure is to provide a storage method that can provide a vehicle with a battery that is in an appropriate state at the time of the replacement.

### Solution to Problem

A storage method according to the present disclosure includes:
keeping an inside of a storage at a constant temperature, wherein the storage is configured to store a battery that is replaceable and that is configured to be detachably attached to a vehicle; and
storing a plurality of the batteries in the storage.

### Advantageous Effects of Invention

The present disclosure is capable of providing a vehicle with a battery that is in an appropriate state at the time of the replacement.

### BRIEF DESCRIPTION OF DRAWINGS

FIG. 1 is a diagram for explaining an application example of a storage method according to an embodiment of the present disclosure;

FIG. 2 is a diagram for explaining an application example of a storage method according to a variation; and

FIG. 3 is a diagram for explaining an application example of a storage method according to another variation.

### DESCRIPTION OF EMBODIMENT

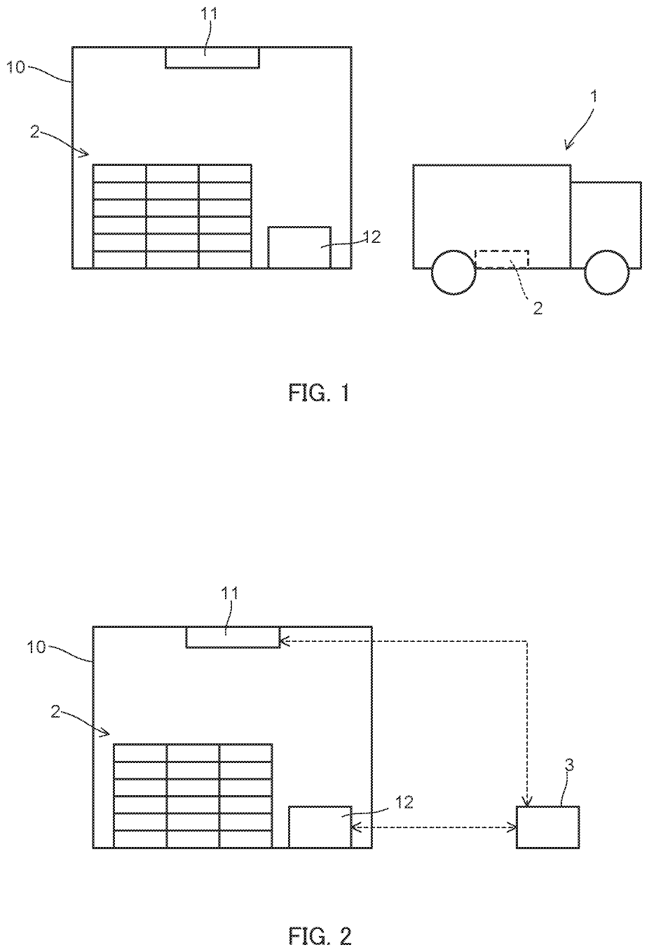

Hereinafter, embodiments of the present disclosure will be described in detail based on the drawings. FIG. 1 is a diagram for explaining an application example of a storage method according to an embodiment of the present disclosure.

Vehicle 1 illustrated in FIG. 1 is a vehicle equipped with battery 2, such as an electric vehicle or a hybrid vehicle. FIG. 1 illustrates vehicle 1 that is a large vehicle such as a truck. Battery 2 to be mounted on vehicle 1 is, for example, a rechargeable storage battery such as a lithium-ion battery. Battery 2 is a replaceable battery that can be attached to and detached from vehicle 1.

Replacing battery 2 is performed, for example, as follows: vehicle 1 moves to a place such as a battery exchange station where storage 10 is located, and then battery 2 that has been removed from vehicle 1 is replaced with battery 2 provided by storage 10.

Storage 10 is a building capable of storing a plurality of batteries 2 and includes air conditioner 11 and charging device 12.

Air conditioner 11 is a device for keeping the inside of storage 10 at a constant temperature. The constant temperature is, for example, a temperature that allows the states of the plurality of batteries 2 stored in storage 10 to become uniform, and may be appropriately set through experiments or the like. In the present embodiment, the constant temperature is set, for example, at 25° C.

In addition, air conditioner 11 is preferably a device capable of keeping the entire area of storage 10 at a constant temperature. This configuration allows the plurality of batteries 2 stored in storage 10 to be stored in a uniform environment.

Charging device 12 is, for example, a known charger capable of charging battery 2. Battery 2 that has been removed from vehicle 1 for the replacement of battery 2 is charged by charging device 12, and then the charged battery 2 (i.e., battery after charging) is stored in storage 10. This configuration allows for management of battery 2 in a certain charged state.

The certain charged state may be, for example, a state of 100% full charge.

In the following, a storage method according to the present embodiment will be described.

First, an operator of storage 10 operates air conditioner 11 to keep the inside of storage 10 at a constant temperature, and stores the plurality of batteries 2 in storage 10. The storage of battery 2 into storage 10 may be performed either after or before the inside of storage 10 is kept at a constant temperature.

In addition, the temperature inside storage 10 is always maintained at a constant temperature. This may be performed, for example, by the operator visually observing a temperature sensor provided in storage 10 or by monitoring information from the temperature sensor by using below-described terminal device 3.

When battery 2 needs to be replaced, the operator of storage 10 takes out battery 2 from storage 10 and replaces battery 2 removed from vehicle 1 with the taken out battery 2. Then, the operator of storage 10 carries battery 2 that has been removed from vehicle 1 into storage 10 and charges battery 2 with charging device 12.

After battery 2 is charged, the operator of storage 10 stores the charged battery 2 in the storage place for battery 2 inside storage 10. Alternatively, battery 2 may be charged with charging device 12 after being stored in the storage place for battery 2. In this case, charging may be performed by connecting charging device 12 with battery 2 via a power cable or the like.

According to the present embodiment configured as above, battery 2 is stored in a space kept at a constant temperature; thus, vehicle 1 can be provided with battery 2 that is in an appropriate state at the time of the replacement.

In addition, battery 2 in storage 10 is managed in a certain charged state; thus, vehicle 1 is more likely to be provided with battery 2 that is in an appropriate state.

Battery 2 collected from vehicle 1 is charged and stored after being charged; thus battery 2 can be appropriately reused.

Battery 2 is charged in storage 10; thus, it is possible to eliminate the effect of environmental change during the transportation of battery 2 from the charging place to the storage place.

In the above embodiment, the deterioration state of battery 2 is not mentioned. As battery 2 is charged many times due to the replacements, the deterioration degree thereof progresses.

Herein, a plurality of batteries 2 are stored in storage 10; thus, the deterioration states of batteries 2 differ from each other. As the deterioration degree progresses, the usage time of battery 2 is expected to become shorter. Therefore, it is necessary to appropriately manage the deterioration state of battery 2 on the storage 10 side before providing battery 2 to vehicle 1.

Therefore, the step of charging battery 2 may include a step of measuring the deterioration state of battery 2.

The deterioration state of battery 2 is measured, for example, by measuring the internal resistance of battery 2 when battery 2 reaches a predetermined charged state (for example, 50%). The deterioration state of battery 2 may be measured after charging is interrupted when battery 2 reaches a predetermined charged state, or may be measured without interrupting charging.

A device for measuring the deterioration state of battery 2 may be, for example, a known device and may be provided in storage 10.

By measuring the deterioration state of battery 2 in this manner, battery 2 can be stored while the deterioration state of battery 2 is managed. As a result, it is possible to appropriately determine whether battery 2 can be provided to vehicle 1 according to the deterioration state of battery 2.

Management of deterioration state of battery 2 may be performed for each battery 2 as follows: a table, in which batteries 2 are associated with the corresponding deterioration states, is stored or recorded in a recording medium such as a computer storage medium or paper.

In addition, the deterioration state may be managed at the storage place for battery 2. For example, when the deterioration state is classified into three levels (such as high, medium, and low), the deterioration state may be managed by dividing the storage place in storage 10 so as to correspond to the levels.

The storage method may include a step of selecting battery 2 to be provided to vehicle 1 for replacement from among the plurality of batteries 2 according to the deterioration state of each battery 2.

For example, when the distance that vehicle 1 is scheduled to travel is fixed, the usage time of battery 2 changes according to the distance. Therefore, battery 2 may be selected, for example, in such a way that the longer the scheduled travel distance is, the lower the deterioration degree is.

Further, for example, when vehicle 1 is a truck or the like, and the weight of the load to be loaded on the loading platform is fixed, the usage time of battery 2 changes according to the required output. Therefore, battery 2 may be selected, for example, in such a way that the higher the required output is, the lower the deterioration degree is.

By selecting battery 2 to be provided according to the deterioration state of each battery 2 in this manner, it is possible to effectively use deteriorated battery 2 while providing appropriate battery 2 to vehicle 1.

In the above embodiment, battery 2 is charged in storage 10; however, the present disclosure is not limited thereto. Battery 2 may be charged outside storage 10.

In the above embodiment, an operator of storage 10 directly operates air conditioner 11 and charging device 12 in storage 10; however, the present disclosure is not limited thereto. For example, as illustrated in FIG. 2, terminal device 3 such as a server provided outside storage 10 may remotely control air conditioner 11, charging device 12, and the like.

For example, terminal device 3 includes a central processing unit (CPU), a read only memory (ROM), a random access memory (RAM), and an input/output circuit (all not illustrated), and controls, for example, air conditioning and charging in storage 10.

Terminal device 3 acquires the temperature inside storage 10 from a temperature sensor or the like provided in storage 10, and controls the air conditioning by air conditioner 11 based on the acquired temperature. This configuration keeps the inside of storage 10 at a constant temperature.

In addition, terminal device 3 controls charging of battery 2 stored in storage place in storage 10. Further, terminal device 3 may store the data of battery 2, for which charging control has been completed, in a storage medium to manage the charged state of battery 2.

Further, terminal device 3 may monitor the charged state of battery 2. For example, when battery 2 is not used for replacement and thus is stored in storage 10 for a long period of time, battery 2 may be discharged to some extent. In such a case, terminal device 3 may recharge this to-some-extent-discharged battery 2.

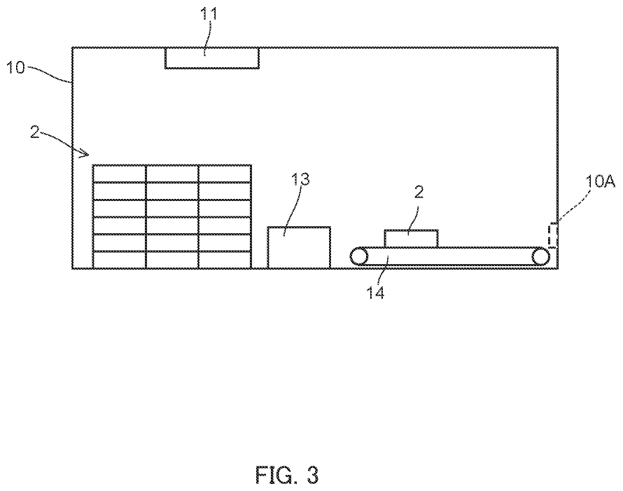

In the above embodiment, an operator of storage 10 performs operation such as carrying battery 2 out of and into storage 10; however, the present disclosure is not limited thereto. For example, as illustrated in FIG. 3, storage 10 may include robot device 13, movement device 14, and the like, and robot device 13 and movement device 14 may automatically perform operation such as carrying battery 2 out of and into the storage.

For example, robot device 13 is installed in the storage place for battery 2 and performs an operation of transporting battery 2 between movement device 14 and the storage place. Specifically, robot device 13 grips battery 2 with an arm capable of gripping battery 2 and transports battery 2 between movement device 14 and the storage place.

Movement device 14 is, for example, a conveyor belt or the like, and moves battery 2 between outlet 10A of storage 10 and the storage place.

When the replacement of battery 2 does not take place, outlet 10A of storage 10 may be closed in order to prevent outside air from entering storage 10.

For example, for replacing battery 2, outlet 10A of storage 10 is opened, and the operator puts battery 2 that has been removed from vehicle 1 into outlet 10A. Then, robot device 13 stores battery 2, which is moved to the vicinity of the storage place via movement device 14, into the storage place.

Further, robot device 13 places battery 2, which is to be provided to vehicle 1, on movement device 14, and movement device 14 moves battery 2 to outlet 10A. An operator outside storage 10 receives battery 2 and provides the battery to vehicle 1.

This configuration reduces the frequency of an operator entering and exiting storage 10, thereby reducing the burden on the operator.

In the above embodiment, air conditioner 11 is used to keep the temperature inside storage 10; however, the present disclosure is not limited thereto. For example, air conditioner 11 may be used to cool battery 2 in view of, for example, heat generation to some extent from battery 2 during the charging.

In the above embodiment, the temperature inside storage 10 is kept constant; however, the present disclosure is not limited thereto. In addition to temperature, humidity may be kept constant (for example, 50%).

The embodiments above are no more than specific examples in carrying out the present disclosure, and the technical scope of the present disclosure is not to be construed in a limitative sense due to the specific examples. That is, the present disclosure can be carried out in various forms without departing from the spirit and the main features thereof.

This application is entitled and claims the benefit of Japanese Patent Application No. 2022-149097, filed on Sep. 20, 2022, the disclosure of which including the specification, drawings and abstract is incorporated herein by reference in its entirety.

### INDUSTRIAL APPLICABILITY

The storage method of the present disclosure is particularly advantageous for providing a vehicle with a battery that is in an appropriate state at the time of the replacement.

1. A storage method, comprising:
keeping an inside of a storage at a constant temperature, wherein the storage is configured to store a battery that is replaceable and that is configured to be detachably attached to a vehicle; and
storing a plurality of the batteries in the storage.

2. The storage method according to claim 1, further comprising:
managing the battery in a certain charged state.

3. The storage method according to claim 1, further comprising:
charging the battery that has been removed from the vehicle for replacement of the battery, wherein
the storing includes storing the charged battery in the storage.

4. The storage method according to claim 3, wherein
the charging includes charging the battery in the storage.

5. The storage method according to claim 3, wherein
the charging includes measuring a deterioration state of the battery.

6. The storage method according to claim 5, further comprising:
selecting the battery to be provided to the vehicle for the replacement from among the plurality of batteries according to the deterioration state of each of the plurality of batteries.
